(19) United States
(12) Patent Application Publication
(10) Pub. No.: US 2013/0003117 A1
(43) Pub. Date: Jan. 3, 2013

(54) PRINTING SYSTEM, PRINT SERVER, PRINTING MANAGEMENT METHOD, AND PROGRAM

(75) Inventor: Kensuke HIRATA, Kawasaki-shi (JP)

(73) Assignee: CANON KABUSHIKI KAISHA, Tokyo (JP)

(21) Appl. No.: 13/495,896

(22) Filed: Jun. 13, 2012

(30) Foreign Application Priority Data
Jun. 28, 2011 (JP) 2011-142995

(51) Int. Cl. G06K 15/02

(52) U.S. Cl. 358/1.15

(57) ABSTRACT

A method for managing a print job, even if there is a firewall between a print server and a printer, includes the print server managing print data and generating a print instruction program causing a client apparatus to execute a print instruction to a printer on a web browser. The client apparatus transmits a print instruction to a data processing unit of the printer, the client apparatus receives a device print job identifier issued by the data processing unit as a response to the print instruction, and the client apparatus notifies the print server of the received device print job identifier.

### BACKGROUND OF THE INVENTION

1. Field of the Invention

The present invention relates to a printing system.

2. Description of the Related Art

In recent years, many businesses have been developed by disclosing their services as cloud services on the Internet. Accordingly, a print server is useful to provide print servicing functions on the Internet. Cloud service provision has various advantages. For example, installing a print server on a large-scale data center eliminates the need of hardware management on a customer basis, facilitates addition of resources according to the load on the print server, and achieves other various advantages. For this reason, there has been a demand for a printing system capable of pull printing, in which the print server transfers print data to a printer via the Internet and then the printer performs printing.

In the printing system in which the print server causes the printer to print, the print server issues a print request and print data to the printer to accomplish printing. Further, the print server communicates with the printer to manage and control a print job currently being executed on the printer. Japanese Patent Application Laid-Open No. 2003-208280 discusses a technique for enabling a client to identify a print job by putting a print job identifier (ID) in a print request and print data. Since a printer manages a print job ID specified by the client, the client can manage and control printing.

With the technique discussed in Japanese Patent Application Laid-Open No. 2003-208280, however, when arranging a print server on the Internet and performing printing on a printer on an intranet, the print server cannot issue a print request to the printer because of a firewall between the print server and the printer, and therefore the print server cannot manage a print job currently being printed on the printer.

### SUMMARY OF THE INVENTION

According to the present invention, a print server issues a print request to a printer via a web browser on an intranet, and the print server is notified of a device job ID issued by the printer via the web browser. In addition, by receiving a print result notification including the device job ID from the printer, the print server can manage a print job currently being printed on the printer. The present invention is directed to management of printing on a printer by a print server beyond a firewall between the print server and the printer.

According to an aspect of the present invention, a printing system includes a print server configured to manage print data and to generate a print instruction program causing a client apparatus to execute a print instruction to a printer on a web browser and a printer including a data processing unit configured to receive the print data from the print server and perform printing based on the print instruction from the client apparatus, wherein the print instruction program causes the client apparatus to transmit the print instruction to the data processing unit of the printer, to receive a device print job identifier issued by the data processing unit as a response to the print instruction, and to notify the print server of the received device print job identifier.

According to the present invention, the print server issues a print request to the printer via the web browser on the intranet, and is notified of a device job ID issued by the printer via the web browser. Further, by receiving a print result notification including the device job ID from the printer, the print server can manage the print job currently being printed on the printer. Printing on the printer can be managed by the print server beyond the firewall between the print server and the printer.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a network configuration.

FIG. 2 illustrates hardware configurations of a print server, a client terminal, and a printer.

FIG. 3 illustrates a module configuration of a printing system.

FIG. 4 illustrates a software configuration of the print server.

FIG. 5 illustrates data managed by the print server.

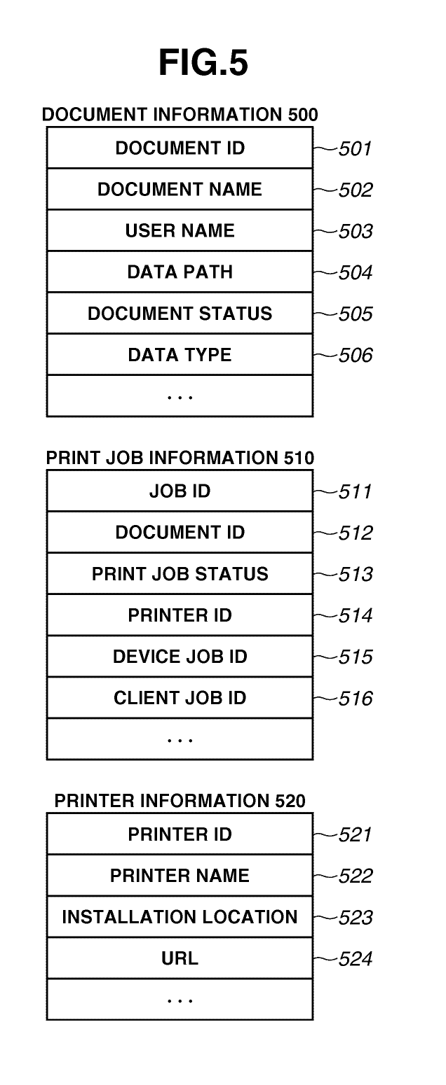

FIG. 6 illustrates an example screen of a web browser.

FIG. 7 illustrates a software configuration of a pull printing application.

FIG. 8 illustrates data managed by the pull printing application.

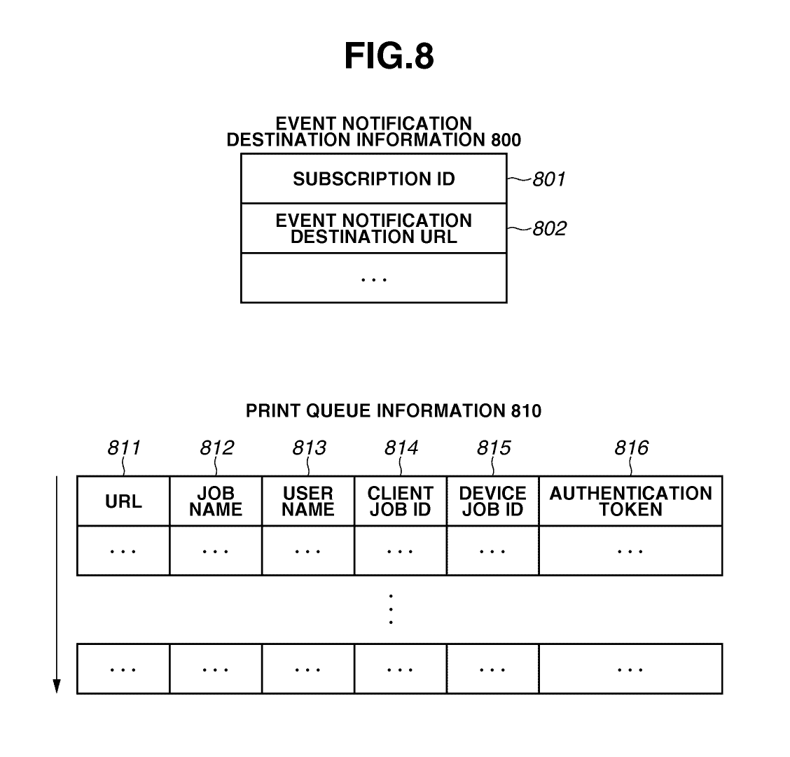

FIG. 9 is a sequence diagram illustrating print request processing.

FIG. 10 is a sequence diagram illustrating pull printing.

FIG. 11 is a flowchart illustrating print request processing by the print server.

FIG. 12 is a flowchart illustrating print request completion notification reception by the printer server.

FIG. 13 is a flowchart illustrating print data acquisition request reception by the print server.

FIG. 14 is a flowchart illustrating print result notification reception by the print server.

### DESCRIPTION OF THE EMBODIMENTS

Various exemplary embodiments, features, and aspects of the invention will be described in detail below with reference to the drawings.

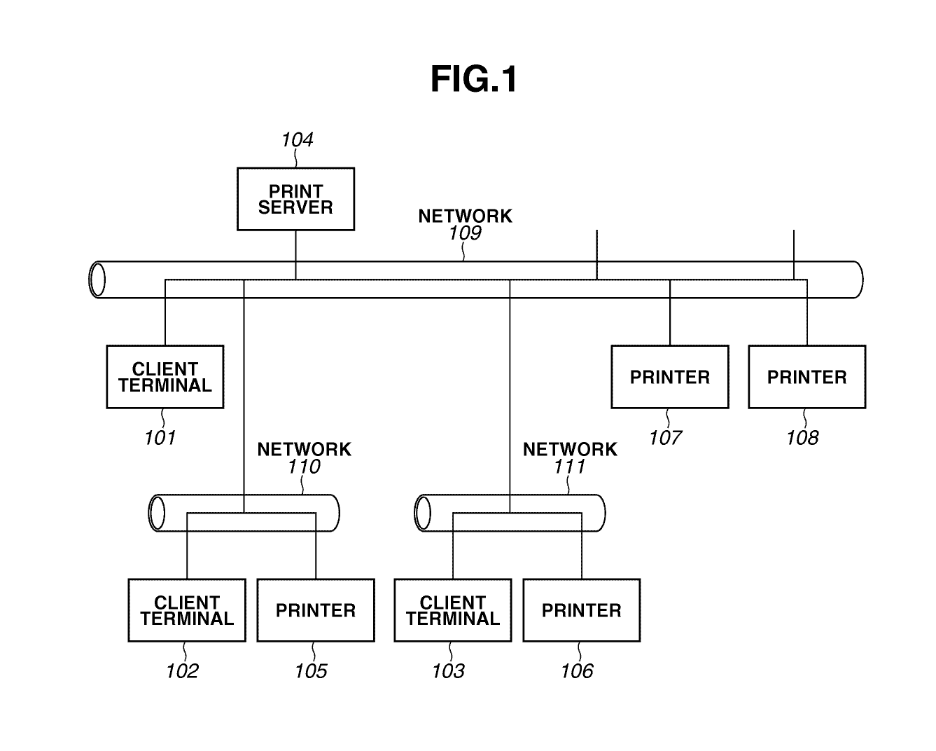

FIG. 1 illustrates an overall configuration of a printing system according to an exemplary embodiment of the present invention. Referring to FIG. 1, client terminals 101 to 103, a print server 104, and printers 105 to 108 are connected with each other via networks 109 to 111. Referring to FIG. 1, it is assumed that a plurality of the client terminals 101 to 103, and a plurality of the printers 105 to 108 are connected.

The networks 109 to 111 include, for example, a local area network (LAN)/wide area network (WAN), such as the Internet, a telephone line, a dedicated digital line, an automatic transaction machine (ATM)/frame relay line, a cable television (TV) line, or a data broadcasting wireless line. The networks 109 to 111 are referred to as communication networks implemented by a combination of above. It is necessary that the networks 109 to 111 are capable of data transmission and reception. Then, a communication method from the client terminals 101 to 103 to the print server 104 and the printers 105 to 108 may differ from a communication method from the printers 105 to 108 to the print server 104.

Although the client terminals 101 to 103 are a desktop personal computer (PC), a notebook PC, a mobile PC, a personal data assistant (PDA), and the like, they may be a mobile phone including a program execution environment. The client terminals 101 to 103 include an environment for executing programs such as a web browser (an Internet browser or a WWW browser, which is a browser for using the world wide web). The print server 104 issues a print request to the printers 105 to 108 via the web browsers of the client terminals 101 to 103. The printers 105 to 108, upon reception of the print request from the web browsers of the client terminals 101 to 103, acquire print data from the print server 104 and then perform printing.

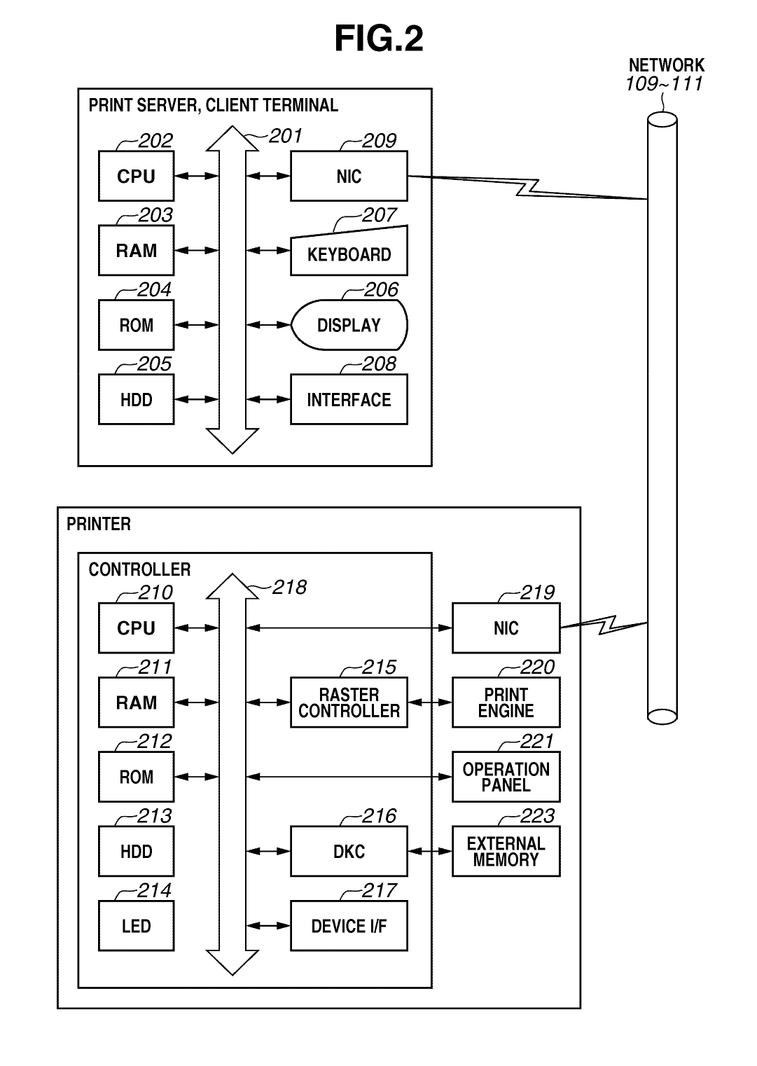

FIG. 2 illustrates a hardware configuration of the client terminals 101 to 103, the print server 104, and the printers 105 to 108 of the printing system according to an exemplary embodiment.

Referring to FIG. 2, a central processing unit (CPU) 202 controls the entire apparatus. More specifically, the CPU 202 executes an application program and an operating system (OS) stored in a hard disk (HDD) 205, and controls a random access memory (RAM) 203 to temporarily store information and files required for program execution. A read-only memory (ROM) 204 is a storage unit for storing programs such as basic input/output (I/O) programs, and various data pieces such as print data and printer information used at the time of print processing. The RAM 203 is a temporary storage unit which serves as a main memory or a work area for the CPU 202. The HDD 205 is an external storage unit which serves as amass storage device. The HDD 205 stores application programs such as web browsers, print server programs, the OS, and related programs.

A display 206 is a display unit for displaying a command input from a keyboard 207 and a printer status. An external device interface (I/F) 208 is used to connect a printer, a Universal Serial Bus (USB) device, and a peripheral device. The keyboard 207 is a command input unit. A system bus 201 manages data flows in the print server 104 of the printing system. A network interface card (NIC) 209 enables data transmission and reception to/from an external device via the networks 109 to 111.

The above-described computer configuration is an example, and the present exemplary embodiment is not limited to the configuration illustrated in FIG. 2. For example, data and programs may be stored in the ROM 204, the RAM 203, or the HDD 205 according to the characteristics thereof.

A controller controls the printers 105 to 108, and manages a control system of these printers. A CPU 210 controls the entire apparatus and generally controls access to/from various devices connected to a system bus 218. The above-described control is based on control programs stored in a ROM 212, and control programs and resource data (resource information) stored in an external memory 223 which is connected to the system bus via a disk controller (DKC) 216. A RAM 211 serves as a main memory or a work area for the CPU 210. The memory capacity of the RAM 211 can be extended by an optional RAM connected to an extension port (not illustrated). An HDD 213 is an external storage unit that serves as a mass storage device for storing a pull printing application program, a printing controller program, and related programs. A pull printing application 304 may be software performed by CPU 210. A pull printing application may also be implemented by a dedicated hardware circuit. A pull printing application is one example of a data processing unit. CPU 210 and dedicated hardware circuit are only some examples of a hardware circuit.

An operation panel 221 is an operation unit including a user interface for performing printing operations. The operation panel 221 further includes buttons and a display unit, such as a liquid crystal panel and a light-emitting diode (LED) 214, for setting operation modes of the printers 105 to 108, displaying operation statuses of the printers 105 to 108, and performing operations such as copy specification. A NIC 219 enables data transmission and reception to/from an external device. A print engine 220 illustrated in FIG. 2 utilizes known printing techniques such as an electrophotographic method (laser beam method), an ink jet method, a sublimation (thermal transfer) method, and the like, as preferable exemplary embodiments. A raster controller 215 converts print data described in the page description language (PDL) and portable document format (PDF) language into image data. A device I/F 217 connects an external device which is connectable via the universal serial bus (USB) to the system bus 218.

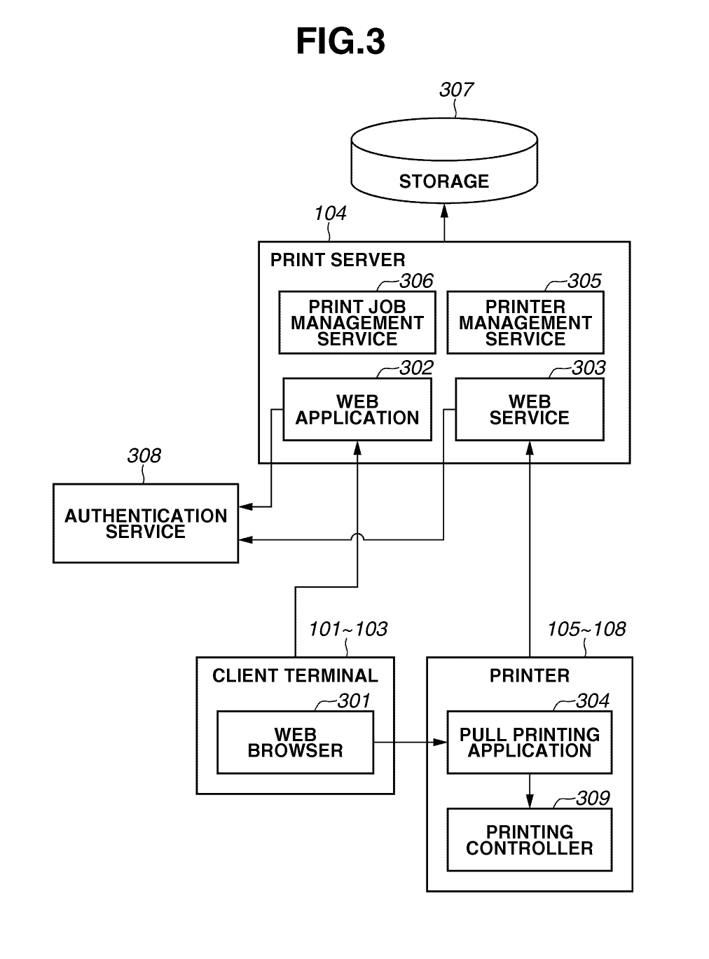

FIG. 3 illustrates a configuration of the printing system according to an exemplary embodiment of the present invention.

A web browser 301 is an application program operating on the client terminals 101 to 103. The web browser 301 displays a web page that can be acquired with a request to a web application 302. Further, the web browser 301 executes a script, for example, to issue a print request to the pull printing application 304.

The pull printing application 304 is an application program operating on the printers 105 to 108. In response to a print request from the web browser 301, the pull printing application 304 acquires print data from the web service 303 and notifies the web service 303 of a print result.

A printing controller 309 is software operating on the printer 105 to 108 to perform printing control. The printing controller 309 receives print data from the pull printing application 304, converts the print data into image data, and executes printing. The printing controller 309 further has functions of receiving print event registration from the pull printing application 304 and notifying it of the print result.

The print server 104 includes a print job management service 306 for managing a print job. The print job management service stores in a storage 307 document data entered from other services and other programs, and manages the document data. The document data has a data format of the PDL or the PDF. The storage 307 is a storage unit such as an HDD included in an information processing apparatus of the print server 104, an externally connected HDD, or a network storage.

A printer management service 305 manages information about the printers 105 to 108 and a connection destination of the pull printing application 304. The web application 302 generates a web page that can be displayed on the web browser 301 operating on the client terminals 101 to 103, and, in response to a request from the web browser 301, returns the generated web page. In response to a print data acquisition request, the web service 303 returns print data and then receives the print result of print processing. The pull printing application 304 of the printers 105 to 108 receives a print request from the web browser 301.

The print job management service 306, the printer management service 305, the web application 302, and the web service 303 are independent programs, and can be installed on different information processing apparatuses. These programs can be installed on information processing apparatuses connected by a network, and perform communication therebetween. Further, these programs may be installed on the same single information processing apparatus.

An authentication service 308 stores authentication information such as a user name, a password, an authentication token, and the like, for accessing the print server 104. When the web application 302 and the web service 303 receive a request, they issue an authentication request to the authentication service 308. In authentication for the web application 302, the authentication service 308 compares a user name and a password included in a login request from a login web page displayed on the web browser 301 with the user name and password stored in the authentication server 308. When the authentication for the web application 302 is successfully completed, the authentication service 308 issues an authentication token associated with an authenticated user. When the authentication token is transferred to the pull printing application 304 via the web browser 301, the pull printing application 304 accesses the web service 303 to check the authentication token and authenticate the request.

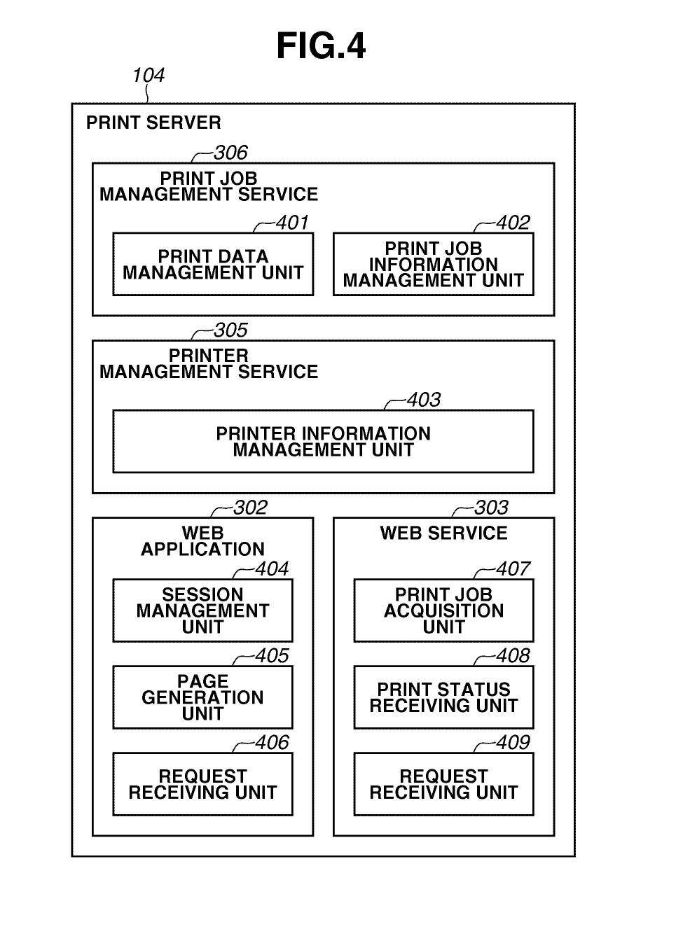

FIG. 4 illustrates a software configuration of the print server 104 according to an exemplary embodiment of the present invention. Software modules of the print server 104 are stored in the HDD 205 illustrated in FIG. 2. As described above, the CPU 202 loads the software module into the RAM 203 and then executes it. Document information 500, print job information 510, and printer information 520, which are stored in the print server 104 are stored in the HDD 205 by the program of the print server 104, loaded and used in the RAM 203.

A print data management unit 401 of the print job management service 306 in the print server 104 manages print data. When the web application 302 receives a print request, the print data management unit 401 acquires document data from the storage 307 and then converts it into print data. When the web service 303 receives a print data acquisition request, the print data management unit 401 transfers to the web service 303 the converted print data to be used as a response to the print data acquisition request. A print job information management unit 402 manages the document information 500 and the print job information 510 stored in the storage 307. More specifically, the print job information management unit 402 generates, deletes, and updates each piece of information.

The document information 500 includes a document ID 501, a document name 502, a user name 503, a data path 504, a document status 505, a data type 506, and the like. The document ID 501 uniquely identifies the document information 500 stored in the print server 104. The document name 502 is assigned to the document data. The user name 503 is a name of an owner of the document data. The data path 504 indicates a location where the document data is stored in the storage 307. The document status 505 includes statuses such as “storing”, “waiting”, “waiting for printing”, “printing”, “normal end”, and “error end”. The data type 506 indicates the format of the document data such as the PDL and the PDF.

The print job information 510 includes a job ID 511, a document ID 512, a print job status 513, a printer ID 514, a device job ID 515, a client job ID 516, and the like. The job ID 511 uniquely identifies the print job information 510 for the document information 500 managed by the print server 104. The document ID 512 is the above-described document ID 501 in the documents information 500. The print job status 513 includes statuses such as “waiting for printing”, “transferring”, “printing”, “normal end”, and “error end”.

The printer ID 514 uniquely identifies the printer information 520 managed by the print service 104. The printer ID 514 corresponds to a printer ID 521 (described below) of the printer information 520. The device job ID 515 is issued by the pull printing application 304 and uniquely identifies a print job managed by the pull printing application 304. The device job ID 515 corresponds to a device job ID 705 (described below) in print queue information 700 of the pull printing application 304. The client job ID 516 uniquely identifies the print job information 510 managed by the print server 104.

The printer information management unit 403 of the printer management service 305 manages the printer information 520 of the printers 105 to 108 managed by the print server 104.

The printer information 520 includes a printer ID 521, a printer name 522, an installation location 523, a uniform resource locator (URL) 524, and the like. The printer ID 521 uniquely identifies the printer information 520 managed by the print server 104. The printer name 522 is the name of the printer. The installation location 523 is printer positional information set in the printer. The URL 524 is an end point used by the print server 104 to issue a request to the pull printing application 304 via the web browser 301.

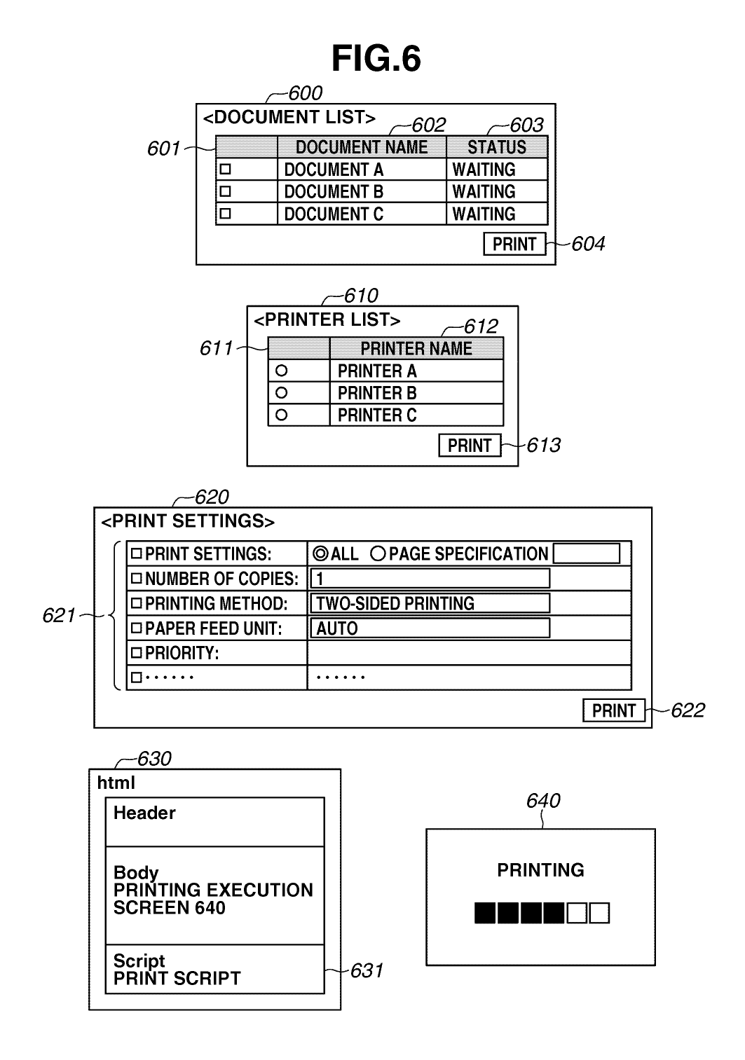

A session management unit 404 of the web application 302 manages as a session a request from the web browser 301, which has been successfully authenticated by the authentication service 308. A page generation unit 405 generates a web screen as illustrated in FIG. 6 in response to the request from the web browser 301, and returns it to the web browser 301. A request receiving unit 406 receives a request from the web browser 301.

A request receiving unit 409 of the web service 303 receives a print data acquisition request and a print result notification from the pull printing application 304. When the request receiving unit 409 receives a print data acquisition request, a print job acquisition unit 407 acquires print data from the print job management service 306. When the request receiving unit 409 receives a print result notification, a printing status receiving unit 408 notifies the print job management service 306 of the relevant status.

FIG. 6 illustrates example web screens generated by the web application 302 of the print server according to an exemplary embodiment of the present invention and displayed by the web browser 301 of the client terminals 101 to 103.

When the web browser 301 issues a request to the print server 104 and the request is successfully authenticated by the authentication service 308, the print server 104 generates a document list screen 600 based on the document information 500 and then transmits it to the web browser 301.

The document list screen 600 includes document selection check boxes 601, document names 602, statuses 603, and a PRINT button 604. The document selection check box 601 is used to select a document to be printed. Upon detection of the pressing of the PRINT button 604, the web browser 301 transmits to the print server 104 a list of documents selected by the document selection check boxes 601. Upon reception of the document list, the print server 104 generates a printer list screen 610 based on the printer information 520 and then transmits it to the web browser 301.

The printer list screen 610 includes printer selection radio buttons 611, printer names 612, and a PRINT button 613. Upon detection of the pressing of the PRINT button 613, the web browser 301 transmits to the print server 104 information about printers selected by the radio buttons 611. Upon reception of the printer information, the print server 104 generates a print setting screen 620 and then transmits it to the web browser 301. The print setting screen 620 is a setting screen for printing attributes 621.

Upon detection of the pressing of a PRINT button 622, the web browser 301 transmits to the print server 104 user-specified printing attributes 621 as a print request. In the print server 104, the specified print attributes 621 are added to the print data.

When the user presses the PRINT button 622 on the print setting screen 620 and the print server 104 receives a print request, the print server 104 generates the print job information 510 based on the information selected in the document list screen 600, the printer list screen 610, and the print setting screen 620. Then, the print server 104 generates a print executing screen 640 and a print script 631 in a screen 630 and then transmits the screen 630 to the web browser 301 as a response to the print request. The print executing screen 640 displays an execution status of the print script 631.

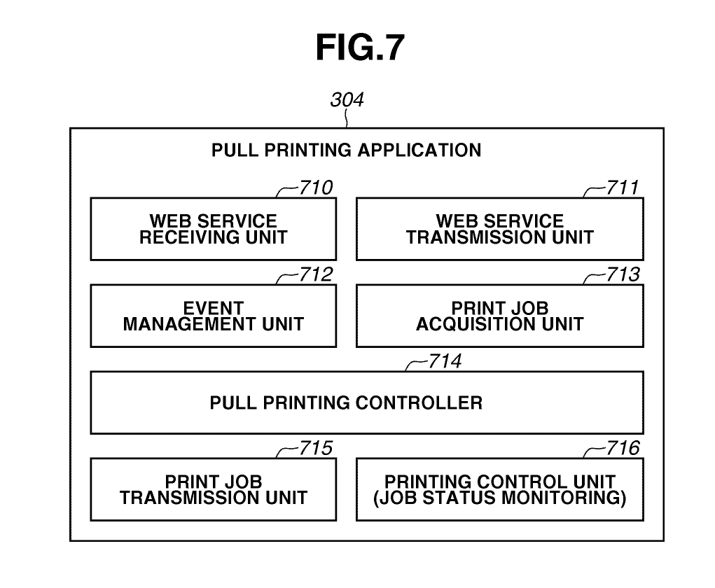

FIG. 7 illustrates a software configuration of the pull printing application 304 according to an exemplary embodiment of the present invention. Software modules of the pull printing application 304 are stored in the HDD 213. As described above, the CPU 210 loads the software module into the RAM 211 and then executes it. Event notification destination information 800 and print queue information 810 stored in the pull printing application 304 are loaded into the RAM 203 and utilized by the program of the pull printing application 304.

A web service receiving unit 710 of the pull printing application 304 receives a printer information acquisition request, an event registration request, a print job generation request, and a print job registration request. A web service transmission unit 711 returns a response to the request received by the web service receiving unit 710, and transmits a print job acquisition request and a print result notification to the print server 104.

An event management unit 712 manages the event registration request information received by the web service receiving unit 710 based on the event notification destination information 800. The event notification destination information 800 includes a subscription ID 801 and an event notification destination URL 802. The subscription ID 801 is used by the pull printing application 304 to uniquely identify the event notification destination information 800. The event notification destination URL 802 indicates a connection destination to transmit the print result notification. The URL of the print server 104 is registered to the event notification destination URL 802.

A print job acquisition unit 713 manages the information about the print job generation request and the print job registration request received by the web service receiving unit 710 based on the print queue information 810. The print queue information 810 includes a URL 811, a job name 812, a user name 813, a client job ID 814, a device job ID 815, and an authentication token 816.

The URL 811 indicates a storage destination of the print data. A uniform resource identifier (URI) of the print service 104 is registered to the URL 811. The document name 502 and the user name 503 managed by the print server 104 are registered to the job name 812 and the user name 813, respectively. The client job ID 814 is used by the client to identify a print job. According to the present exemplary embodiment, the client job ID 516 in the print job information 510, which is issued by the print server 104, is registered to the client job ID 814.

The device job ID 815 uniquely identifies a print job issued by the pull printing application 304. According to the present exemplary embodiment, an integer starting from one is registered as the device job ID 815, and the pull printing application 304 increments the device job ID 815 each time a print job generation request is received.

The authentication token 816 is the authentication token issued by the authentication service 308. When the print data acquisition request is issued, the pull printing application 304 adds the authentication token 816 to the print data acquisition request. The print server 104 can check the consistency of the authentication token 816 by the authentication service 308. The print job acquisition unit 713 registers at the end of the print queue information 810 the print job generation request information received by the web service receiving unit 710. The print job acquisition unit 713 issues the print data acquisition request via the web service transmission unit 711 based on the print job information at the top of the print queue information 810.

A print job transmission unit 715 transfers to the printing controller 309 the print data acquired based on the print data acquisition request from the print job acquisition unit 713.

A printing control unit 716 monitors a printing status of the print data transmitted from the print job transmission unit 715 to the printing controller 309, and then notifies the event management unit 712 of the print result (print result notification). The printing control unit 716 starts monitoring the printing status when the pull printing application 304 registers a print event to the printing controller 309 and then receives a print result notification.

A pull printing controller 714 controls the overall operation of the pull printing application 304. An operation instruction is issued to each unit via the pull printing controller 714.

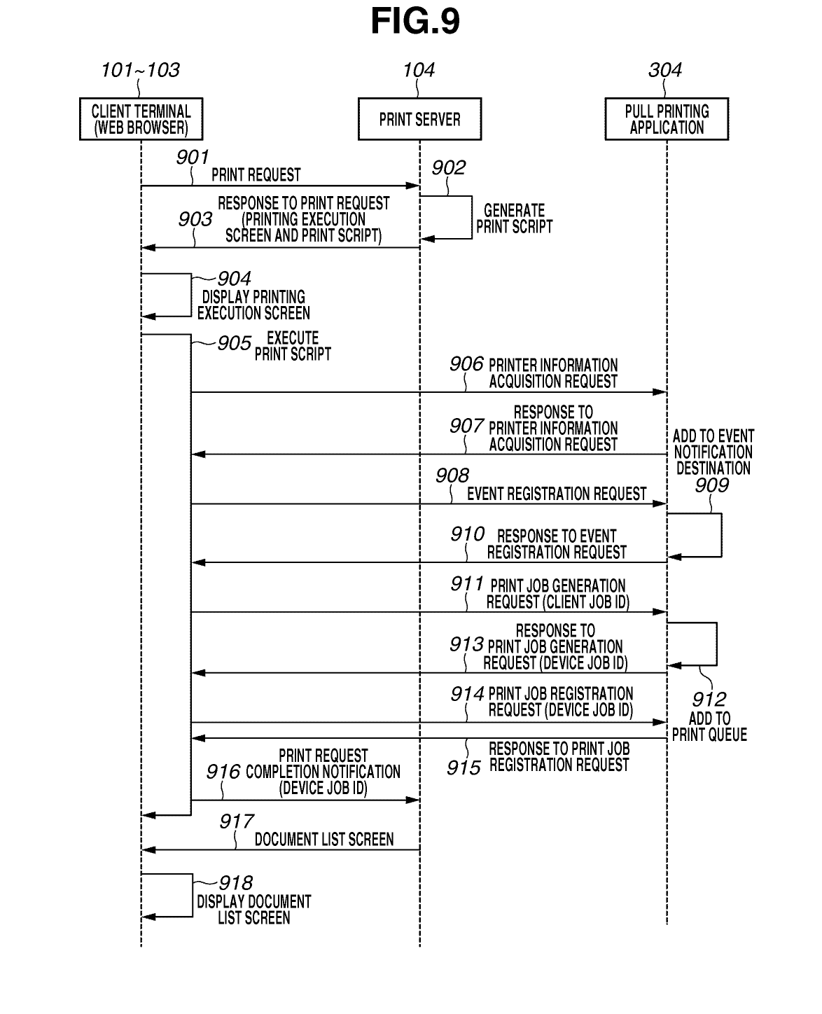

FIG. 9 illustrates a sequence from when the web browser 301 requests the print server 104 to execute printing, i.e., when the user presses the PRINT button 622 on the print setting screen illustrated in FIG. 6, until when a print request is issued to the pull printing application 304.

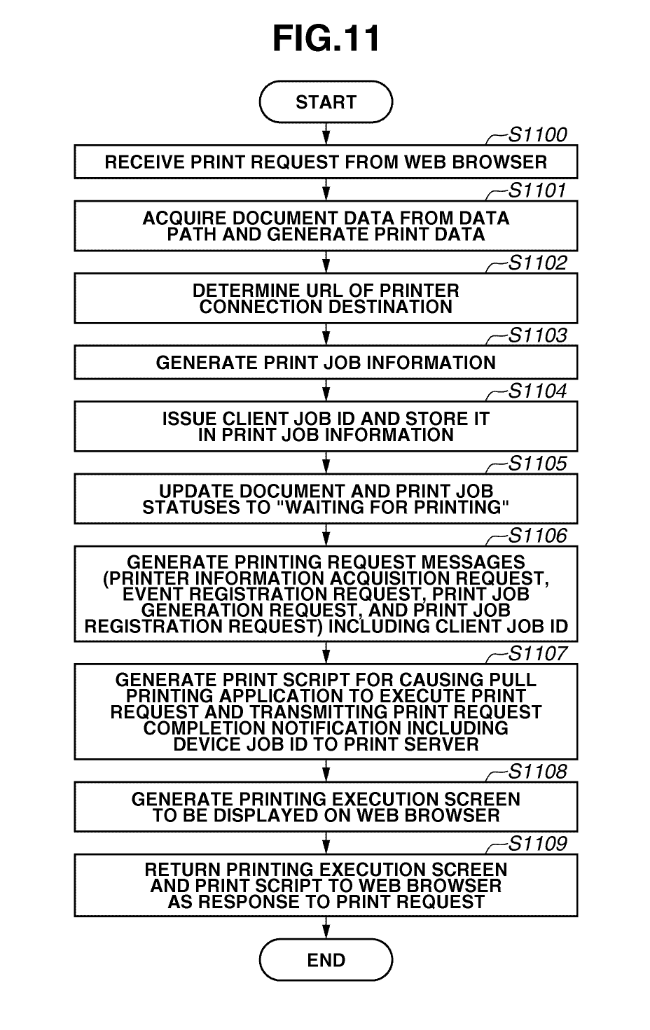

In step 901, the web browser 301 issues a print request to the print server 104. Upon reception of the print request, in step 902, the print server 104 generates a print script. The print script includes a program for executing steps 905 to 916, which are described below, on the web browser 301. In step 903, the print server 104 transmits to the web browser 301 the print script together with the printing execution screen 604 as a response to the print request. Then, the web browser 301 executes the print script in steps 905 to 916 as described below. FIG. 11 is a flowchart illustrating detailed processing in which the print server 104 receives the print request in step 901 and then returns the response to the print request in step 903.

Upon reception of the response to the print request in step 903, the web browser 301 displays the printing execution screen 604 in step 904. In step 905, the web browser 301 executes the print script. During the execution of the print script, the processing in steps 906 to 916 is performed on the web browser 301.

During the processing in steps 906 to 915, the web browser 301 first issues a printing request to the pull printing application 304. The connection destination of the pull printing application 304 subjected to the print request is the URL 524 of the printer information 520 selected in the printer list screen 610.

In step 906, the web browser 301 issues a printer information acquisition request to the pull printing application 304 to check the consistency between the printer information 520 and the pull printing application 304 subjected to the print request. In step 907, the pull printing application 304 returns to the web browser 301 a response to the printer information acquisition request, which includes a printer ID. When the printer ID included in the response matches the printer ID 521 of the print server 104, the consistency can be checked. When the printer ID included in the response does not match the printer ID 521, subsequent print request is not issued and the processing is regarded as a print error.

In step 908, the web browser 301 issues an event registration request to the pull printing application 304. The event registration request specifies the URL of the print server 104 as the event notification destination URL 802. Upon reception of the event registration request, in step 909, the pull printing application 304 issues the subscription ID 801 and then adds the URL of the print server 104 to the event notification destination URL 802. In step 910, the pull printing application 304 returns the issued subscription ID 801 to the web browser 301 as a response to the event registration request.

In step 911, the web browser 301 issues a print job generation request to the pull printing application 304. The print job generation request includes the document name 502, the user name 503, and the client job ID 516 managed by the print server 104. The print job generation request is issued by using the document information 500 and the print job information 510 identified based on the document selected in the document list screen 600.

Upon reception of the print job generation request, in step 912, the pull printing application 304 adds the print job generation request information to the print queue information 810. The pull printing application 304 registers the document name 502 as the job name 812, the user name 503 as the user name 813, and the client job ID 516 as the client job ID 814. Then, the pull printing application 304 generates a device job ID 815 and registers the generated device job ID 815 to the print queue information 810. In step 913, the pull printing application 304 returns to the web browser 301 the device job ID 515 issued by the pull printing application 304 as a response to the print job generation request.

In step 914, the web browser 301 issues a print job registration request to the pull printing application 304. The print job registration request is issued by specifying the device job ID 515 returned as the response to the print job generation request. Further, the print job registration request includes the URL of the print server 104 and the authentication token issued by the authentication service 308. Upon reception of the print job registration request, the pull printing application 304 searches for print jobs having the device job ID 815 matched with that specified by the print job registration request in the print queue information 810. Then, the pull printing application 304 registers the URL of the print server 104 to the URL 811 of the print jobs having the matched device job ID 815, and registers the authentication token issued by the authentication service 308 to the authentication token 816. Upon completion of the registration of the print queue information 810, in step 915, the pull printing application 304 returns to the web browser 301 a response to the print job registration request.

In step 916, the web browser 301 transmits a print request completion notification to the print server 104. The print request completion notification includes the device job ID 815 in the response to the print job generation request in step 913 returned from the pull printing application 304. Upon reception of the device job ID 815 with the print request completion notification, the print server 104 stores it as the device job ID 515 in the print job information 510 used when the print job generation request is issued. In step 917, the print server 104 returns to the web browser 301 the document list screen 600 as a response to the print request completion notification. In step 918, the web browser 301 displays the document list screen 600.

Accordingly, the processing in which the print request is issued from the print server 104 to the pull printing application 304 via the web browser 301 can be performed as described above in the sequence. Although the print job generation request in step 911 and the print job registration request in step 914 are issued only once in FIG. 9, the requests are issued a plurality of number of times when the user selects a plurality of documents in the document list screen 600. Accordingly, a plurality of device job IDs is notified by the print request completion notification in step 916.

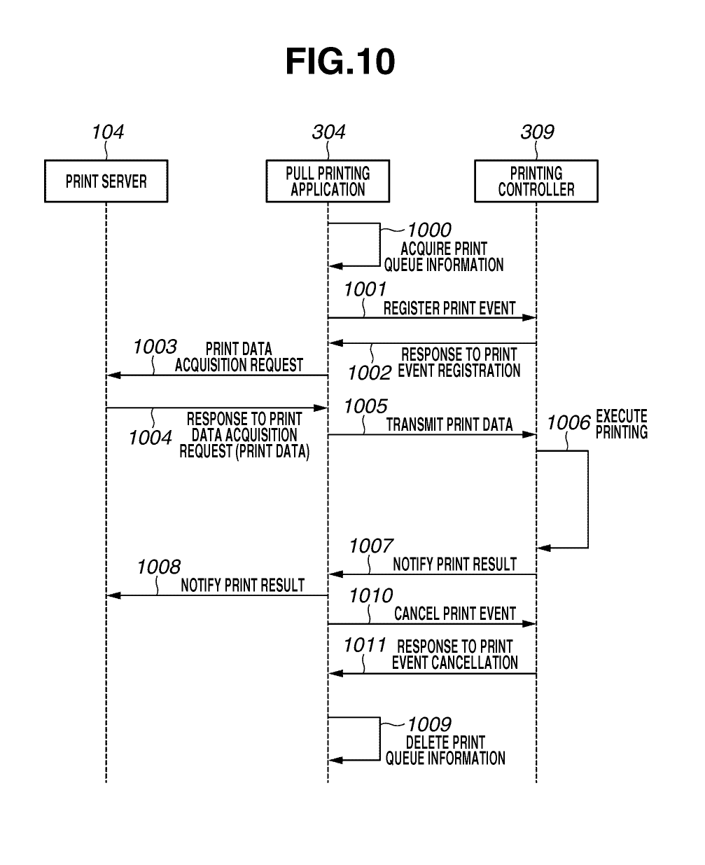

FIG. 10 illustrates a sequence in which the pull printing application 304 acquires the print data from the print server 104 based on the print queue information 810, executes printing, and after completion of printing, notifies the print server 104 of the print result.

The pull printing application 304 manages the print queue information 810. In step 1000, when the print job information 510 is registered in the print queue information 810, the pull printing application 304 acquires the first print job information 510 and then starts print processing.

In step 1001, the pull printing application 304 registers a print event to the printing controller 309. Instep 1002, the pull printing application 304 receives a response to the print event registration. After registering the print event to the printing controller 309, the pull printing application 304 can receive a print result notification (described below in step 1008) from the printing controller 309.

In step 1003, the pull printing application 304 issues a print data acquisition request to the print server 104. The connection destination of the print data acquisition request in step 1003 is the URL 811 of the print queue information 810. The URL of the print server 104 is registered with the above-described print job registration request in step 914. The print data acquisition request in step 1003 includes the client job ID 814, the device job ID, and the authentication token 816.

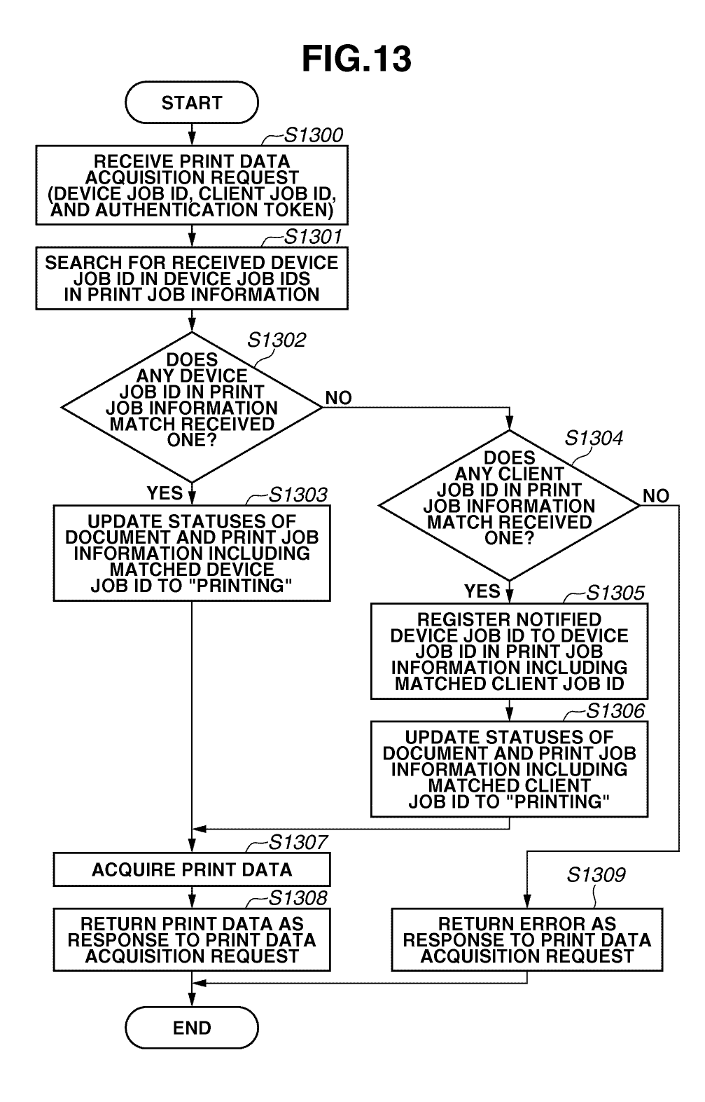

Upon reception of the print data acquisition request in step 1003, the print server 104 checks the validity of the authentication token 816 using the authentication service 308. When the authentication token 816 is valid, in step 1004, the print server 104 returns to the pull printing application 304 the print data corresponding to the client job ID 814 and the device job ID 815 as a response to the print data acquisition request. FIG. 13 is a flowchart illustrating detailed processing in which the print server 104 receives the print data acquisition request in step 1003 and then returns the response to the print data acquisition request in step 1004.

In step 1005, the pull printing application 304 transmits to the printing controller 309 the print data transferred from the print server 104 in the response to the print data acquisition request instep 1004. Instep 1006, the printing controller 309 executes printing.

In step 1006, the printing controller 309 completes printing, and then in step 1007, the printing controller 309 notifies the pull printing application 304 of the print result. In step 1008, based on the print result notification in step 1007, the pull printing application 304 transmits the print result notification to the print server 104. The connection destination for the print result notification in step 1008 is the event notification destination URL 802 in the event notification destination information 800. The URL of the print server 104 is registered as the event notification destination URL 802 when the event registration request is issued in step 908. The print result notification in step 1008 includes the print result, the client job ID 814, and the device job ID 815. The print result includes “normal end”, “end by cancellation”, “error end”, and the like.

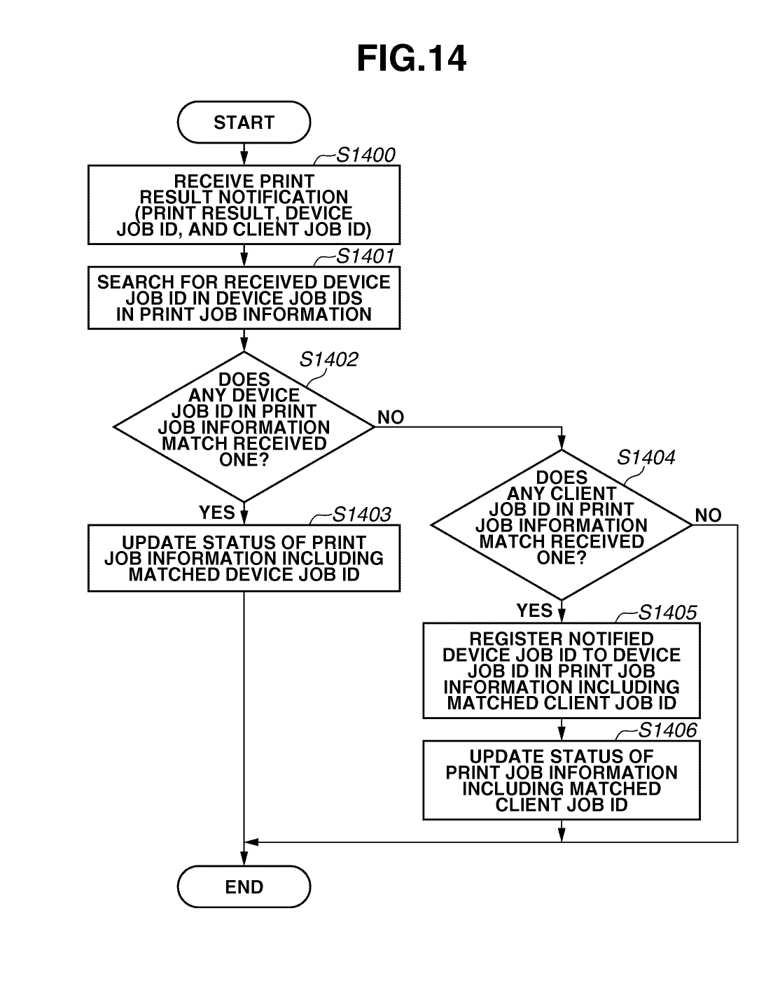

Upon reception of the print result notification in step 1008, the print server 104 updates to the print result the document status 505 and the print job status 513 corresponding to the notified client job ID 814 and device job ID 815. FIG. 14 is a flowchart illustrating detailed processing in which the print server 104 receives the print result notification instep 1008 and then updates the statuses 505 and 513.

In step 1010, the pull printing application 304 cancels the print event which is registered in step 1001 to the printing controller 309. In step 1011, the printing controller 309 returns to the pull printing application 304 a response to the print event cancellation.

Upon completion of print processing, in step 1009, the pull printing application 304 deletes the relevant print information from the print queue information 810. Then, control returns to step 1000 to start print processing for the following print job.

FIG. 11 illustrates processing in which the print server 104 receives the print request in step 901 from the web browser 301 and then returns the response to the print request in step 903.

In step S1100, the print server 104 receives a print request from the web browser 301. In step S1101, the print server 104 acquires document data from the data path 504 in the document information 500 selected in the document list screen 600, and starts print data generation. The print server 104 stores and manages the generated print data in the HDD 205. In step S1102, the print server 104 determines a connection destination subjected to the print request based on the URL 524 of the printer information 520 selected in the printer list screen 610.

In step S1103, the print server 104 generates the print job information 510 based on the document information 500 and the printer information 520. The print server 104 issues the job ID 511. The print server 104 registers the document ID 501 in the document information 500 as the document ID 512, and the printer ID 521 of the printer information 520 as the printer ID 514. In step S1104, the print server 104 issues and registers a universally unique identifier (UUID) of the client job ID 516. In step S1105, the print server 104 updates the document status 505 and the print job status 513 to “waiting for printing.”

In step S1106, the print server 104 generates a printing request message to be transmitted to the pull printing application 304. The generated message include the printer information acquisition request in step 906, the event registration request in step 908, the print job generation request in step 911, and the print job registration request in step 914. The information included in each request is as illustrated in FIG. 9.

In step S1107, the print server 104 generates a print script. The generated print script is a program that can be executed by the web browser 301. When the web browser 301 executes the print script, the processing in steps 905 to 916 (see FIG. 9) is executed on the web browser 301. The print script transmits the printing request message generated in step S1107 to the pull printing application 304 and then receives a response therefrom in steps 906 to 915. The print script further transmits the print request completion notification in step 916 to the print server 104. The processing of the print script on the web browser 301 is as illustrated in FIG. 9.

In step S1108, the print server 104 generates the print executing screen 640. In step S1109, the print server 104 returns the print executing screen 640 and the print script to the web browser 301 as the response to the print request (step 903).

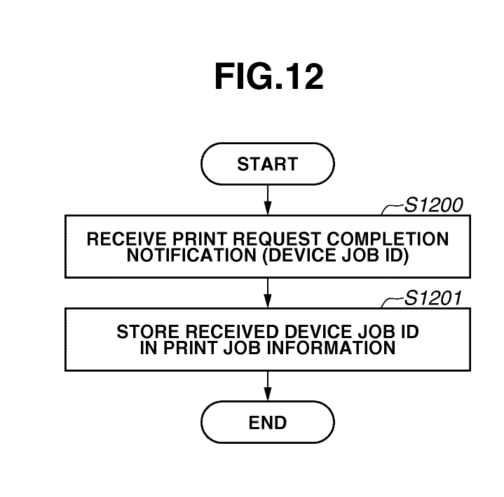

FIG. 12 is a flowchart illustrating processing in which the print script is executed by the web browser 301 and then the print server 104 receives the print request completion notification (step 916). In step S1200, the print server 104 receives the print request completion notification (step 916). In step S1201, the print server 104 registers the device job ID notified by the print request completion notification (step 916) to the device job ID 515 in the print job information 510 generated in step S1103.

Since the print server 104 stores the device job ID 515, the print server 104 can issue print cancellation to the pull printing application 304 using the device job ID 515. Based on the print result notification from the pull printing application 304, the print server 104 can identify the print job information 510 using the device job ID 515, which is described below with reference to FIG. 14. Thus, the print server 104 can manage and control printing on the printers 105 to 108.

The processing flows illustrated in FIGS. 11 and 12 are stored in the HDD 205 as a program of the print server 104. The CPU 202 loads the program into the RAM 203 and then executes it. The document information 500, the print job information 510, and the printer information 520 used in the processing illustrated in FIGS. 11 and 12 are stored in the HDD 205 and loaded into the RAM 203 by the program of the print server 104.

The print script is generated by the program of the print server 104 in step S1107, and stored in the RAM 203 of the print server 104. Upon reception of the print script, the web browser 301 stores it in the HDD 205 of the client terminals 101 to 103, loads it into the RAM 203, and then executes it. The web browser 301 is stored in the HDD 205 as a program operating on the client terminals 101 to 103. The CPU 202 loads the program of the web browser 301 into the RAM 203 and then executes it.

FIG. 13 illustrates the processing in which the print server 104 receives the print data acquisition request in step 1003 from the pull printing application 304 and then returns the response to the print data acquisition request in step 1004.

In step S1300, the print server 104 receives the print data acquisition request (step 1003) from the pull printing application 304 to receive the client job ID 814, the device job ID 815, and the authentication token 816. Although not illustrated, the print server 104 checks the validity of the received authentication token 816 with the authentication service 308. When the authentication token 816 is valid, the print server 104 performs processing from step S1301. Otherwise, when the authentication token 816 is invalid, the print server 104 recognizes the response to the print data acquisition request as an error, and does not perform printing.

In step S1301, the print server 104 searches the device job IDs 515 in the print job information 510 for the device job ID 815 received in the print data acquisition request (step 1003).

In step S1302, the print server 104 determines whether any of the device job IDs 515 matches the device job ID 815. When any of the device job IDs 515 matches the device job ID 815 (YES in step S1302), the processing proceeds to step S1303. In step S1303, the print server 104 updates to “printing” the relevant print job status 513 in the print job information 510. Further, the print server 104 similarly updates to “printing” the document status 505 in the document information 500 associated with the document ID 512 in the print job information 510.

When none of the device job IDs 515 matches the device job ID 815 (NO in step S1302), the processing proceeds to step S1304.

In step S1304, the print server 104 searches the client job IDs 516 in the print job information 510 for the client job ID 814 received in the print data acquisition request (step 1003).

When the print server determines that there is any of the client job IDs 516 matches the client job ID 814 (YES in step S1304), the processing proceeds to step S1305.

In step S1305, the print server 104 registers the device job ID 815 notified by the print data acquisition request (step 1003) to the device job ID 515 in the print job information 510 which includes the matched client job ID 516. Further, the print server 104 updates to “printing” the print job status 513 in the print job information 510. In step S1306, the print server 104 similarly updates to “printing” the document status 505 in the document information 500 associated with the document ID 512 in the print job information 510.

When none of the device job IDs 516 matches the client job ID 814 (NO in step S1304), the processing proceeds to step S1309. In step S1309, the print server 104 returns an error to the pull printing application 304 as the response to the print data acquisition request (step 1004).

In step S1307, the print server 104 acquires the print data generated and stored in the HDD 205 instep S1101. Instep S1308, the print server 104 returns the acquired print data as the response to the print data acquisition request (step 1004) to the pull printing application 304.

The print server 104 can store the device job ID 815 notified in the print request completion notification (step 916). However, the web browser 301 may be stopped during execution of the print script, and the print request completion notification may not be transmitted in step 916. Since the print server 104 stores the device job ID 515 when issuing the print data acquisition request, the print server 104 can manage the device job ID 515 even if the print request completion notification in step 916 is not received. By using the device job ID 515, the print server 104 can issue print cancellation to the pull printing application 304 . Based on the print result notification from the pull printing application 304, the print server 104 can identify the print job information 510 using the device job ID 515, which is described below with reference to FIG. 14. Thus, the print server 104 can manage and control printing on the printers 105 to 108.

The processing flow illustrated in FIG. 13 is stored in the HDD 205 as a program of the print server 104. The CPU 202 loads the program into the RAM 203 and then executes it. The document information 500 and the print job information 510 used in the processing illustrated in FIG. 13 are stored in the HDD 205 and loaded into the RAM 203 by the program of the print server 104.

FIG. 14 illustrates processing performed by the print server 104 upon reception of the print result notification (step 1008) from the pull printing application 304.

Instep S1400, the print server 104 receives the print result notification (step 1008) from the pull printing application 304 to receive the print result, the client job ID 814, and the device job ID 815. The notified print result includes “normal end”, “end by cancellation”, “error end”, and the like.

In step S1401, the print server 104 searches the device job IDs 515 in the print job information 510 for the device job ID 815 received in the print result notification (step 1008).

In step S1402, the print server 104 determines whether any of the device job IDs 515 matches the device job ID 815. When any of the device job IDs 515 matches the device job ID 815 (YES instep S1402), the processing proceeds to step S1403. In step S1403, the print server 104 updates to the print result the relevant print job status 513 in the print job information 510. In step S1403, the print server 104 similarly updates to the print result the document status 505 in the document information 500 associated with the document ID 512 in the print job information 510.

When none of the device job IDs 515 matches the device job ID 815 (NO in step S1402), the processing proceeds to step S1404.

In step 51404, the print server 104 searches the client job IDs 516 in the print job information 510 for the client job ID 814 received in the print result notification (step 1008).

The print server 104 determines whether any of the client job IDs 516 matches the client job ID 814. When any of the client job IDs 516 matches the client job ID 814 (YES in step S1404), the processing proceeds to step S1405. In step S1405, the print server 104 registers the device job ID 815 notified in the print data acquisition request to the device job IDs 515 in the print job information 510 having the matched client job ID 516. Further, the print server updates the print job status 513 in the print job information 510 to the print result. In step S1406, the print server 104 similarly updates to the print result the document status 505 in the document information 500 associated with the document ID 512 in the print job information 510.

When none of the device job IDs 516 matches the client job ID 814 (NO in step S1404), the processing in this flowchart is ended.

The print server 104 stores the device job ID 815 notified in the print request completion notification (step 916) or in the print data acquisition request (step 1003). Using the device job ID 515 enables identifying the print job information 510 in the print result notification from the pull printing application 304. Thus, the print server 104 can manage and control printing on the printers 105 to 108.

The processing flow illustrated in FIG. 14 is stored in the HDD 205 as a program of the print server 104. The CPU 202 loads the program into the RAM 203 and then executes it. The document information 500 and the print job information 510 used in the processing illustrated in FIG. 13 are stored in the HDD 205 and loaded into the RAM 203 by the program of the print server 104.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-142995 filed Jun. 28, 2011, which is hereby incorporated by reference in its entirety.

What is claimed is:

1. A printing system comprising:
a print server configured to manage print data and to generate a print instruction program causing a client apparatus to execute a print instruction to a printer on a web browser; and
a printer including a data processing unit configured to receive the print data from the print server and perform printing based on the print instruction from the client apparatus,
wherein executing the print instruction program causes
the client apparatus to transmit the print instruction to the data processing unit of the printer,
the client apparatus to receive a device print job identifier issued by the data processing unit as a response to the print instruction, and
the client apparatus to notify the print server of the received device print job identifier.

2. The printing system according to claim 1,
wherein the data processing unit notifies the print server of a result of printing performed by the print instruction and a printer print job identifier,
wherein the print server determines whether a device print job identifier matching the device print job identifier notified from the data processing unit is stored therein, and
wherein the print server updates, based on a result of the determination, a printing status of a print job which includes the matched device print job identifier.

3. The printing system according to claim 1,
wherein the print instruction to the data processing unit includes a client print job identifier issued by the print server,
wherein the data processing unit notifies the print server of a result of printing performed by the print instruction, the client print job identifier, and the device job identifier, and
wherein the print server
determines whether a device print job identifier matching the device print job identifier notified from the data processing unit is stored therein,
determines, if no device print job identifier matching the device print job identifier notified from the data processing unit is stored therein, whether a client print job identifier matching the client print job identifier notified from the data processing unit is stored therein,
registers the device print job identifier notified from the data processing unit to a print job which includes the matched client print job identifier, and
updates a printing status of the print job which includes the matched client print job identifier.

4. The printing system according to claim 3,
wherein, when print data is acquired from the print server, the data processing unit notifies the print server of the printer print job identifier and the client print job identifier, and
wherein the print server
determines whether a device print job identifier matching the device print job identifier notified from the data processing unit is stored therein,
determines if no device print job identifier matching the device print job identifier notified from the data processing unit is stored therein, whether a client print job identifier matching the client print job identifier notified from the data processing unit is stored therein, and
registers the device print job identifier notified from the data processing unit to a print job which includes the matched client print job identifier.

5. A print server configured to manage print data and to generate a print instruction program causing a client apparatus to execute a print instruction to a printer on a web browser,
wherein executing the print instruction program causes
the client apparatus to transmit a print instruction to a data processing unit of the printer,
the client apparatus to receive a device print job identifier issued by the data processing unit as a response to the print instruction, and
the client apparatus to notify the print server of the received device print job identifier.

6. A method for managing printing, the method comprising:
managing print data, via a print server, to generate a print instruction program causing a client apparatus to execute a print instruction to a printer on a web browser;
transmitting a print instruction, via the client apparatus, to a data processing unit of the printer;
receiving a device print job identifier, via the client apparatus, issued by the data processing unit responsive to the print instruction; and
notifying, via the client apparatus, the print server of the received device print job identifier.

7. A non-transitory computer readable medium storing instructions that when executed, cause a computer to function as a print server according to claim 5.
